(19) United States
(12) Patent Application Publication
(10) Pub. No.: US 2026/0227613 A1
(43) Pub. Date: Aug. 6, 2026

(54) Light Reflector Element and Atomic Device

(71) Applicant: DEUTSCHES ZENTRUM FÜR LUFT- UND RAUMFAHRT E.V., Bonn-Oberkassel (DE)

(72) Inventors: Christian SCHUBERT, Hannover (DE); Waldemar HERR, Hannover (DE); Vanessa Annablle GRAUER, Eschwege (DE); Carsten KLEMPT, Hemmingen (DE)

(21) Appl. No.: 19/407,641

(22) Filed: Dec. 3, 2025

(30) Foreign Application Priority Data
Dec. 6, 2024 (DE) 10 2024 136 457.2

(51) Int. Cl. G02B 17/00; G21K 1/30

(52) U.S. Cl. CPC G02B 17/002; G21K 1/30

(57) ABSTRACT

A light reflector element has a plurality of reflector surfaces which are aligned at one or more predefined angles with respect to a predefined light incidence. The reflector surfaces may be are arranged annularly around a center of the light reflector element. The reflector surfaces are arranged opposite one another with respect to the center of the light reflector element so that light shining in the light incidence direction is deviated by the reflector surfaces into light rays that converge with one another in different spatial directions and meet at a central axis which extends through the center of the light reflector element in the light incidence direction. The central axis is aligned parallel to the light incidence direction. The light rays of several or all of the reflector surfaces can meet at the same point of the central axis, which then forms an interaction zone for the cooling of trapped atoms. The light reflector element has particular application in an atom interferometer or a quantum gradiometer. The light reflector element may be used in any atomic device having an atom trap and atoms which are laser-cooled in the atom trap, in particular having a magneto-optical trap (MOT).

### FIELD OF THE INVENTION

The invention relates to a light reflector element which has a plurality of reflector surfaces, which are aligned at one or more predefined angles with respect to a predefined light incidence direction of the light reflector element, wherein the reflector surfaces are arranged, for example annularly, around a center of the light reflector element, wherein the reflector surfaces are arranged opposite one another with respect to the center of the light reflector element so that light shining in the light incidence direction is deviated by the reflector surfaces into light rays that converge with one another in different spatial directions and meet at a central axis which extends through the center of the light reflector element in the light incidence direction. The central axis is therefore aligned parallel to the light incidence direction. The light rays of a several or all of the reflector surfaces, which are deviated by the reflector surfaces, can in this case meet at the same point of the central axis, which then forms an interaction zone for the cooling of trapped atoms.

The invention also relates to an atomic device, for example an atom interferometer or a quantum gradiometer, having at least one such light reflector element. In general, the invention relates to the field of any atomic devices having an atom trap and atoms which are laser-cooled in the atom trap, in particular having a magneto-optical trap (MOT). In particular, the invention relates to atom-interferometric gravimeters as well as to gradiometers formed therewith.

### BACKGROUND

Atom-interferometric gravimeters offer long-term stable absolute gravity measurements. In contrast to the widespread laser gravimeters (FG5X), their measurement principle offers the possibility of quasi-continuous data acquisition over a prolonged period of time and the prospect of higher accuracy. Transportable commercial devices based on atom-interferometric measurements have already been produced, and also operated on a mobile platform such as a ship. One essential constituent of an atom-interferometric gravimeter is the source of cold atoms. Typically, these are based on laser cooling in magneto-optical traps and polarization gradient cooling. Besides magnetic fields, a three-dimensional magneto-optical trap also requires light fields, which are typically shined antiparallel on the three spatial axes in order to form a so-called interaction zone for the cooling of trapped atoms. This involves a relatively complex structure with multiple beamforming optics and corresponding optical accesses to the vacuum system in which the atoms are trapped and cooled. Specially designed pyramidal structures or grating structures have successfully been used to provide a beam geometry, which can effectively cool in all three spatial axes, from a single incident laser beam.

A further important application of atom interferometers is their use for gradiometers in which two spatially separated gravimeters are operated simultaneously. The first derivative of the force of gravity, i.e. the gravity gradient, can be derived from the difference signal. There is common-noise rejection for the difference signal, where the gradiometer signal is affected only by technical noise sources which act differently on the two gravimeters. It is particularly important for the two gravimeters to be operated as symmetrically as possible in order to obtain the greatest benefit from the aforementioned noise rejection.

The prior art in gradiometry with compact atom interferometers is described well by the publication WO 2014/106811 A2. The gradiometer therein consists of two (or three) interaction zones, in each of which laser light is directed onto a sample of atoms from all six spatial directions. A single laser beam is used for this purpose, which is directed by two (or three) light reflector elements respectively onto the interaction zones. The two light reflector elements are arranged so that the second light reflector element lies behind a central hole of the first light reflector element (and if applicable the third light reflector element has a central hole for the second light reflector element).

The technical challenge of taking acceleration measurements with cold atoms consists in implementing compact and robust devices in order to generate reliable measurement data and to maintain high sensitivities in spite of exacting dynamic environmental conditions. For gradiometric measurements in particular, these aspects are currently becoming more crucial and the demands on the sensors are high.

Current implementations for the cooling and trapping of atom clouds with a view to the subsequent interferometry process involve various pyramidal mirrors or grating configurations of the 3-dimensional magneto-optical trap (3D MOT). These types of 3D MOTs have contributed to the structures for atom interferometers being more compact, since only one laser beam is therefore required or the number of optical accesses and fibers needed is significantly reduced. However, the associated optical elements are expensive to produce and may involve the need for further elements in the structure, which can lead to undesired polarization effects or phase perturbations. One challenge in this case is the uniform intensity distribution of the laser light in all three spatial axes for the 3D magneto-optical trap and molasses cooling. This is however very important because a nonuniform distribution of the light affects the performance of the laser cooling that is being carried out, and can therefore degrade the performance of the sensor overall.

Current implementations of pyramidal MOTs are usually designed so that they illuminate four of the six spatial directions needed for effective cooling by reflective surfaces. The other two directions are each covered by the incident laser light field reflected on itself.

The typical variants with reflection at an angle of 90° require a liquid crystal variable retarder (LCVR) in the retro-reflection path for switching between the MOT phase and the interferometry phase, or detection phase, during the interferometry cycle when an energy transition conducive to the detection is intended to be driven in the atom (for example a so-called closed transition).

### SUMMARY

The object of the invention is therefore to provide an improved light reflector element and an atomic device formed therewith.

This object is achieved by a light reflector element of the type mentioned in the introduction wherein one, several or all of the reflector surfaces are aligned at an angle not equal to 45° with respect to the predefined light incidence direction of the light reflector element. The reflector surfaces therefore deviate the light shined in the light incidence direction not orthogonally to the light incidence direction, but at an oblique angle thereto. This may for example be implemented in the form of pyramidal optics. By the optimized angle of deviation of the reflector surfaces, incident light rays are deviated at an angle in relation to the surface normal so that overall the vector contributions of the light fields still cover all spatial axes, i.e. they have components in all spatial axes, without the light which passes through the light reflector element at the center having to be reflected on itself for operation as a magneto-optical trap, i.e. does not need to be reflected back by a mirror arranged behind the light reflector element in the light incidence direction. This has the advantage that a controllable polarization element, for example an LCVR, for switching between the MOT phase and the interferometry phase, or detection phase, during the interferometry cycle is not required in the retro-reflection path since such a retro-reflection path per se is no longer needed for the magneto-optical trap. By obviating the controllable polarization element, phase errors in the atom interferometer due to wavefront perturbations can likewise be reduced. It is also possible to arrange coils for the magneto-optical trap on or in the vacuum chamber instead of around the vacuum chamber.

Application possibilities of the light reflector element are not restricted to atom interferometers. An access is advantageously left free behind the light reflector element in the light beam direction, where no mirror is needed for retro-reflection in the light incidence direction. This access may for example be used for an optical dipole trap, detection optics, an atomic oven or the like in a different atom-optical structure.

According to one advantageous embodiment of the invention, one, several or all of the reflector surfaces are aligned at an angle in the range of from 46° to 89°, in particular at an angle of 67.5°, with respect to the predefined light incidence direction of the light reflector element. Generally speaking, the reflector surfaces may be aligned at an angle of more than 45°. In this way, the light shined in the light incidence direction is shined back at least partially counter to the light incidence direction, at least with a certain vector component in the reflected light rays. This makes it possible to omit the retro-reflection mirror behind the light reflector element. The reflected light rays therefore meet at a position which lies in front of the reflector surfaces in the light incidence direction.

According to one advantageous embodiment of the invention, one, several or all of the reflector surfaces are aligned at an angle in the range of from 1° to 44°, in particular at an angle of 22.5°, with respect to the predefined light incidence direction of the light reflector element. In this embodiment, the reflected light rays meet behind the reflector surfaces in the light incidence direction. This variant may advantageously be used for other types of atom optics, for example when a second light source, which generates light to be emitted counter to the light incidence direction, is present on the side facing away from the light reflector element as seen in the light incidence direction.

According to one advantageous embodiment of the invention, several or all of the reflector surfaces are aligned at the same angle with respect to the predefined light incidence direction of the light reflector element. The reflector surfaces therefore lead to a reflection sense in the same direction along the central axis, in front of the reflector surfaces or behind the reflector surfaces in the light incidence direction depending on the alignment of the reflector surfaces.

The reflector surfaces may be arranged around the central axis at equal angular distances from one another in the circumferential direction.

According to one advantageous embodiment of the invention, a light-transmitting portion, through which the light incident in the light incidence direction can shine through the light reflector element, is respectively arranged between neighboring reflector surfaces in the circumferential direction. In the light reflector element according to the invention, therefore, not only a central inner region of the light reflector element is configured to transmit light, as in the prior art, but portions which transmit light are alternatively or additionally provided between the reflector surfaces in the circumferential direction. Advantages may be achieved by such a configuration of the light reflector element:
less area to be covered for the laser beam in the case of successively arranged light reflector elements
symmetrical intensity distribution in the interaction zones
improved symmetries in the number of atoms in the two interaction zones
corresponding improvement of the gradiometer signal by systematic effects
reduction of the apparatus size with advantages for compactness
less laser power required and therefore reduced restrictions for compact structure and the power consumption

The invention enables an improved design of the light reflector elements, in which the splitting of the available laser light is achieved not by radial or transmissive segmentation of the reflector surfaces, but by an angle-dependent segmentation of the reflector surfaces. This allows a symmetry in the optical configuration. At the same time, it reduces the complexity of the light reflector elements, which do not necessarily need to be made from a material which transmits light and may be configured identically for all of the two, three or more interaction zones. Manufacture is thereby simplified. By the use of identical optical elements, the symmetry furthermore reduces differential errors which might otherwise affect the signal quality.

The light reflector element may for example be formed with reflector surfaces arranged in pairs. In this case, the light reflector element may have at least two pairs of reflector surfaces, the reflector surfaces of a pair of reflector surfaces each being arranged opposite one another, symmetrically with respect to the center of the light reflector element, so that light shining through the pairs of reflector surfaces in the light incidence direction is deviated into light rays which travel at least in two mutually orthogonally arranged spatial axes and meet at the central axis.

It is also possible not to form the light reflector element with reflector surfaces arranged in pairs. For example, the light reflector element can three reflector surfaces, which are arranged at an equal angular distance from one another (i.e. 120 degrees), for example annularly around the center of the light reflector element.

The reflector surfaces are adapted to reflect light, in particular with a reflection factor of substantially 100%, although a reflectivity >80% may also be sufficient. The reflector surfaces may for example be configured as mirrors. The reflector surfaces may be configured as uniform, two-dimensionally continuous reflector surfaces or as a multiplicity of individual reflector surfaces, which are arranged in a staggered manner next to one another on the reflector element. A reflector surface may be delimited from a neighboring reflector surface by being arranged at a different angle than the neighboring reflector surface and/or with an offset from the neighboring reflector surface. A reflector surface may for example be configured as a plane reflective surface.

According to one advantageous embodiment of the invention, one, several or all of the light-transmitting portions are configured as free space in which no material is arranged. This has the advantage that free spaces have more advantageous optical transmission properties than light-transmitting portions filled with material. Further, according to one advantageous embodiment of the invention, the light reflector element may be configured particularly straightforwardly and produced by simple methods. Alternatively, a filler material which transmits light, for example a glass material or plastic material, may also be arranged in one, several or all light-transmitting portions.

According to one advantageous embodiment of the invention, the reflector surfaces are arranged at a distance from the center so that a central light-transmitting portion, through which the light incident in the light incidence direction can shine through the light reflector element, is formed around the center. For example, the light of the light source may be sent through the central light-transmitting portion to a mirror arranged behind the light reflector element in the light incidence direction, or a further light reflector element arranged behind the latter, by which the light is reflected in order to carry out the interferometry.

The light reflector element may be composed of multiple different individual parts. For example, the individual reflector surfaces may be applied as mirrored components on a base component, which acts as a carrier for the reflector surfaces.

According to one advantageous embodiment of the invention, the light reflector element is configured as a monolithic component. This allows very straightforward and economical production of a light reflector element, which is also mechanically very stable. It also simplifies integration of the light reflector element into an atom interferometer, and the adjustment is simplified.

The object mentioned in the introduction is also achieved by a reflector arrangement which has at least one first light reflector element and at least one second light reflector element, wherein the second light reflector element is arranged behind the first light reflector element in the light incidence direction. The first light reflector element is configured as a light reflector element of the type described above, i.e. as a light reflector element according to the invention. The second light reflector element may also be configured as a light reflector element according to the invention, although it may also be configured differently. The light shining through the light-transmitting portions of the first light reflector element can impinge on the reflector surfaces of the second light reflector element. Two interaction zones of a quantum gradiometer may advantageously be formed by such a reflector arrangement. The area required to be covered for the laser beam is in this case relatively small. A symmetrical intensity distribution may also be achieved straightforwardly in the interaction zones.

Advantageously, the first light reflector element and the second light reflector element may be configured with the same size in respect of the dimensions of their optically effective reflector surfaces. It is further advantageous for the second light reflector element to be arranged behind the first light reflector element in the light incidence direction along the same central axis, that is to say arranged concentrically with the first light reflector element.

The object mentioned in the introduction is also achieved by an atomic device, in particular an atom interferometer, having at least one laser light source and an atom trap, which has at least one interaction zone for the cooling of trapped atoms by the laser light of the laser light source shining onto the trapped atoms from opposite directions, wherein the atomic device has a first light reflector element of the type explained above, the light emission direction of the laser light source being aligned in the predefined light incidence direction of the first light reflector element, the first interaction zone being formed at least partly by the light reflector element. The advantages explained above may also thereby be achieved. The atomic device may be any atomic device having laser-cooled atoms in the atom trap. The atom trap may be configured as a magneto-optical trap (MOT).

The atom trap may be configured as a three-dimensionally acting atom trap (for example a 3D MOT), the vector components of the laser light shining onto the trapped atoms from opposite directions in the first interaction zone comprising all spatial axes. The structure of the atomic device may also thereby be simplified.

The magneto-optical trap functions as an atom trap which is adapted to trap an atom cloud. The magneto-optical trap has a magnetic field instrument so as to produce a magnetically effective part of the atom trap. The atom interferometer further has at least one controllable laser light source, for example a laser, by which the light can be emitted in the predefined light incidence direction onto the light reflector element or elements, or the reflector arrangement. The laser cooling of the trapped atoms in the interaction zone or zones is thereby achieved.

According to one advantageous embodiment of the invention, the atom trap is formed on the side of the first light reflector element facing away from the laser light source without a light ray path extending along the central axis. Accordingly, the retro-reflection light path may be avoided at least for the cooling of the atoms, so that the phase errors in the atom interferometer can be minimized and the overall structure can be simplified, in particular without requiring an LCVR or similar module for controlling the light shined back.

According to one advantageous embodiment of the invention, the atomic device has at least two interaction zones for the cooling of trapped atoms by laser light shining onto the trapped atoms from opposite directions, the atomic device having a second light reflector element, which is arranged behind the first light reflector element in the light incidence direction, a second interaction zone being formed at least partly by the second light reflector element. The atomic device may for example have a reflector arrangement of the type described above. The second light reflector element may be configured as a light reflector element according to the invention, as described above, or a differently configured light reflector element, for example a light reflector element according to the prior art. The atomic device may for example be configured as a quantum gradiometer.

The invention is suitable for example for applications in the field of navigation, for rotation and acceleration measurements, for example as part of an inertial quantum measurement unit to assist or replace conventional inertial measurement units, particularly in regions

without a reliable global navigation system (GNSS).

In the context of the present invention, the indefinite term “a” is not to be understood as a numeral. When a component is referred to, for example, this is to be interpreted in the sense of “at least one component”. When angles are given in degrees, these refer to a circular measurement of 360 degrees (360°).

### DESCRIPTION OF THE DRAWINGS

The invention is explained in more detail below with the aid of exemplary embodiments by using drawings.

FIG. 1 shows a light reflector element in a plan view,

FIG. 2 shows the light reflector element according to FIG. 1 in a lateral sectional view,

FIG. 3 shows an atomic device in a highly schematized lateral sectional view,

FIG. 4 shows a reflector arrangement having two light reflector elements in a perspective view.

### DETAILED DESCRIPTION

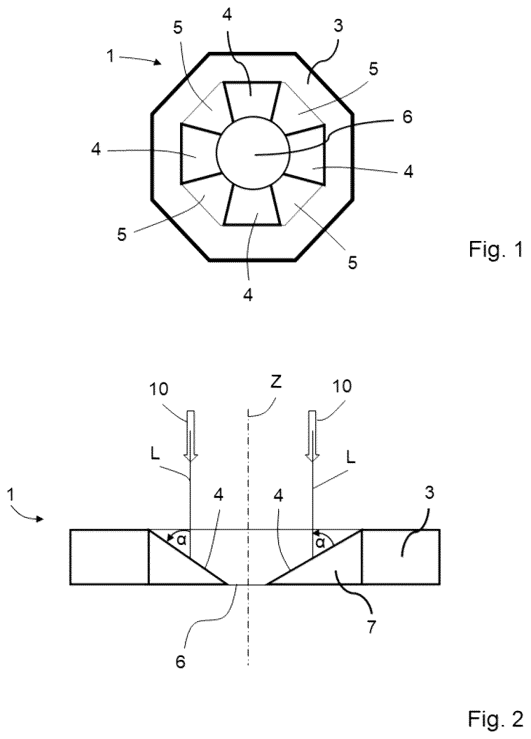

The light reflector element 1 according to FIGS. 1, 2 has a base body 3, on which a plurality of reflector surfaces 4 arranged uniformly distributed over a circumferential angle coordinate are arranged while facing obliquely in the opposite direction to a predefined light incidence direction L of the light reflector element 1. The reflector surfaces 4 are each configured as specular surfaces of a reflector body 7. The reflector surfaces 4 may respectively be arranged opposite in pairs, i.e. two opposite reflector surfaces 4 form a pair of reflector surfaces, although other arrangements may also be envisioned. The reflector surfaces 4 are each arranged opposite one another, symmetrically with respect to a center of the light reflector element 1, in particular point-symmetrically or mirror-symmetrically. The center of the light reflector element 1 is illustrated in FIG. 2 by a central axis Z. The central axis Z extends through the center of the light reflector element 1 in the light incidence direction L.

Between neighboring reflector surfaces 4 in the circumferential direction around the central axis Z, there may respectively be a light-transmitting portion 5 which, for example, can be configured as a free space in which no material is arranged. Alternatively, the regions 5 may also be filled with the material of the base body 3 or another material. The reflector surfaces 4 do not reach as far as the central axis Z in the radial direction, but end at a distance from the central axis Z so that a central light-transmitting portion 6 is formed around the central axis Z. The central light-transmitting portion 6 may be configured as a free space in which no material is arranged.

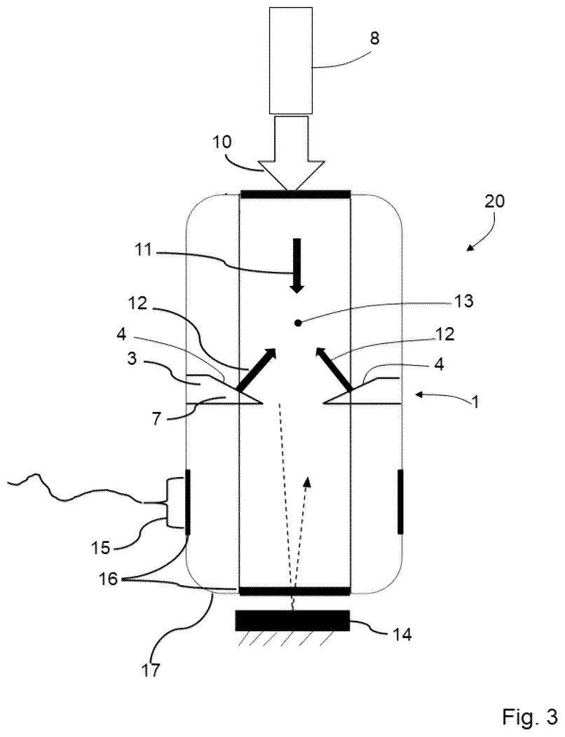

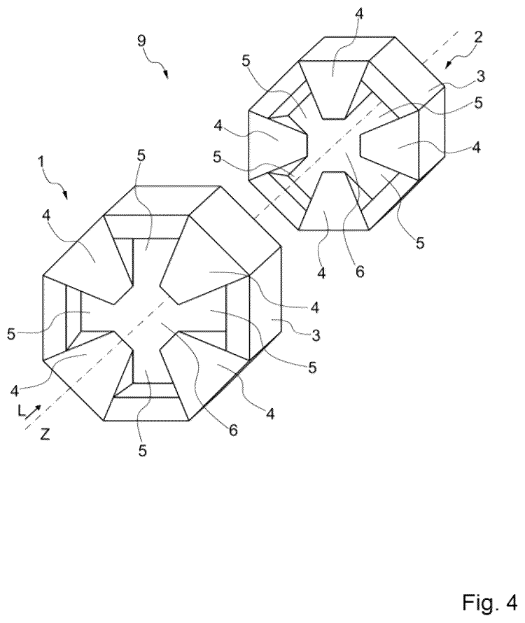

As may be seen particularly in FIG. 2, in contrast to the prior art, the reflector surfaces 4 are aligned at an angle α not equal to 45°, for example at an angle of 67.5°, with respect to the predefined light incidence direction L. This has the effect that the light rays 10 incident in the light incidence direction L are not deviated by the respective reflector surface 4 at an angle of 90° in the direction of the central axis Z, but instead at an oblique angle thereto, so that the reflected light rays have a vector component opposite to the incident light 10. This is explained in more detail below with the aid of FIG. 3. If the angle α has a value of 67.5°, the light rays reflected at the reflector surface 4 are reflected back at an angle of 45°.

FIG. 3 shows an atomic device 20, for example an atom interferometer. The atomic device 20 has a coherent light source 8, for example a laser, by which the light 10 is emitted in the light incidence direction L. The atomic device 20 further has a vacuum chamber 17, in which a light reflector element 1 of the type described above is arranged. It can be seen that the wave vector 11 of the incident light 10, which is aligned in the light incidence direction L in relation to the light reflector element 1, is directed onto an interaction zone 13 in which atoms are trapped in an atom trap and can be cooled by the laser light. The direction of the light of the light source 8 which is reflected at the reflector surfaces 4 is additionally represented by wave vectors 12. Because of the oblique alignment of the reflector surfaces 4, which is not equal to an angle of 45°, the wave vectors 12 have a component opposite to the wave vector 11 and are likewise aligned at the interaction zone 13. In this way, vector light components in all six spatial directions are encountered in the interaction zone 13, so that a three-dimensionally acting atom trap can already be achieved with the one light reflector element 1 without requiring reflection by a mirror behind the light reflector element 1. In this way, three-dimensional laser cooling of the atoms is possible with little outlay.

Because of the light reflector element 1 with its reflector surfaces 4 aligned obliquely, i.e. not at an angle of 45°, the light shined in is reflected so that the wave vector has both a component antiparallel to the incident light field wave vector 11 and a component perpendicular thereto. By the configuration of the light reflector element 1, the optics allow a uniform light pressure on the atoms in the direction of the light incidence direction L and opposite to the light incidence direction L.

For subsequently carrying out an interferometry cycle, the atoms trapped in the atom trap, i.e. the interaction zone 13, may then be extracted and for example fall down in the vacuum chamber 17. The vacuum chamber 17 may contain optical transparent view ports through which the interferometry outputs can then be evaluated, for example by means of a camera or a photodiode. There may also be a mirror 14 for the interferometry on the side of the vacuum chamber 17 facing away from the light source 8. A detection system 15 for the evaluation of the interferometer outputs may be placed in front of a view port 16.

Instead of the four reflector elements 4 represented in the 90°-offset arrangement, only three elements which are offset by 120° from one another, or alternatively six reflector elements 4 in a 60°-offset arrangement could also for example be envisioned.

The mirror 14 may also be mounted inside the vacuum chamber 17. It is also conceivable to mount the mirror 14 on a remote-controlled mirror holder, in such a way that the reflected part of the light field can be tilted by automatic control so that the effect on the magneto-optical trap is reduced. A further alternative for minimizing its effect on the magneto-optical trap is, for example, to arrange a shutter between the lower view port 16 and the mirror 14.

The described exemplary embodiment of the optics likewise allows a structure with two successively arranged light reflector elements 1, 2 which form a reflector arrangement 9, as is described below with the aid of FIG. 4. With such a reflector arrangement 9, for example, a quantum gradiometer may be produced so that the gravity gradient can be measured with one light source 8.

FIG. 4 shows a reflector arrangement 9 having two light reflector elements 1, 2, which are arranged successively in a predefined light incidence direction L of the light reflector elements 1, 2. In the light incidence direction L there is a initially a first light reflector element 1 and a second light reflector element 2 behind it.

The light reflector elements 1, 2 each have a base body 3, on which a plurality of reflector surfaces 4 arranged uniformly distributed over a circumferential angle coordinate are arranged while facing in the opposite direction to the light incidence direction L. The light reflector elements 1, 2 may, for example, be configured as described with the aid of FIGS. 1, 2. The central axis Z extends through the center of the two light reflector elements 1, 2 in the light incidence direction L. The light reflector elements 1, 2 are therefore arranged concentrically with one another.

The second light reflector element 2 may be arranged rotated by an angle of 45° about the central axis Z relative to the first light reflector element 1. This makes it possible for light shining in the light incidence direction L, which shines through the light-transmitting portions 5 of the first light reflector element 1, to impinge precisely on the reflector surfaces 4 of the second light reflector element 2.

1. A light reflector element, comprising:
a plurality of reflector surfaces which are aligned at one or more predefined angles with respect to a predefined light incidence direction, wherein the plurality of reflector surfaces are arranged opposite one another with respect to a center of the light reflector element so that light shining in the light incidence direction is deviated by each of the plurality of reflector surfaces into light rays that converge with one another in different spatial directions and meet at a central axis which extends through the center of the light reflector element in the light incidence direction, wherein one, several or all of the plurality of reflector surfaces are aligned at an angle not equal to 45° with respect to the predefined light incidence direction of the light reflector element.

2. The light reflector element according to claim 1, wherein one, several or all of the plurality of reflector surfaces are aligned at an angle ranging from 46° to 89° with respect to the predefined light incidence direction of the light reflector element.

3. The light reflector element of claim 2 wherein the angle is 67.5°.

4. The light reflector element according to claim 1, wherein one, several or all of the plurality of reflector surfaces are aligned at an angle ranging from 1° to 44° with respect to the predefined light incidence direction of the light reflector element.

5. The light reflector element of claim 3 wherein the angle is 22.5°.

6. The light reflector element according to claim 1 wherein several or all of the plurality of reflector surfaces are aligned at a same angle with respect to the predefined light incidence direction of the light reflector element.

7. The light reflector element according to claim 6 wherein several or all of the light-transmitting portions are configured as free space in which no material is arranged.

8. The light reflector element according to claim further comprising a light-transmitting portion through which the light incident in the light incidence direction shines through the light reflector element, wherein the light-transmitting portion is arranged between neighboring reflector surfaces of the plurality of reflector surfaces in the circumferential direction.

9. The light reflector element according to claim 1 wherein each of the plurality of reflector surfaces are arranged at a distance from a center of the light reflector element so that a central light-transmitting portion, through which the light incident in the light incidence direction shines through the light reflector element, is formed around the center of the light reflector element.

10. The light reflector element according to claim 1 wherein the light reflector element is configured as a monolithic component.

11. The light reflector element according to claim 1 wherein one, several or all of the plurality of reflector surfaces are respectively configured as a plane surface.

12. The light reflector element of claim 1 wherein the plurality of reflector surfaces are arranged annularly around a center of the light reflector element.

13. An atomic device, comprising:
at least one laser light source;
an atom trap which has at least one interaction zone for cooling of trapped atoms by laser light of the at least one laser light source shining onto the trapped atoms from opposite directions;
a first light reflector element according to claim 1, wherein a light emission direction of the at least one laser light source is aligned in the predefined light incidence direction of the first light reflector element, and wherein the at least one interaction zone is or comprises a first interaction zone formed at least partly by the light reflector element.

14. The atomic device according to claim 13, wherein the atom trap is configured as a three-dimensionally acting atom trap, wherein vector components of the laser light shining onto the trapped atoms from opposite directions in the first interaction zone comprise all spatial axes.

15. The atomic device according to claim 13 wherein the atom trap is formed on a side of the first light reflector element facing away from the at least one laser light source without a light ray path extending along the central axis.

16. The atomic device according to claim 13 wherein the at least one interaction zone comprises at least two interaction zones separated from one another for the cooling of trapped atoms by laser light shining onto the trapped atoms from opposite directions, the atomic device having a second light reflector element arranged behind the first light reflector element in the light incidence direction, wherein a second interaction zone of the at least two interaction zones is formed at least partly by the second light reflector element.

17. The atomic device of claim 13 configured as an atom interferometer.

18. The atomic device of claim 13 configured as a quantum gradiometer.
